(19) United States
(12) Patent Application Publication
(10) Pub. No.: US 2019/0263041 A1
(43) Pub. Date: Aug. 29, 2019

(54) MULTI-LAYER BLOWING HEAD FOR A BLOWN FILM INSTALLATION, BLOWN FILM INSTALLATION, AND METHOD FOR OPERATING A BLOWN FILM INSTALLATION

(71) Applicant: REIFENHÄUSER GMBH & CO. KG MASCHINENFABRIK, Troisdorf (DE)

(72) Inventor: Christoph LETTOWSKY, Aachen (DE)

(21) Appl. No.: 16/319,954

(22) PCT Filed: May 10, 2017
(86) PCT No.: PCT/DE2017/000124

§ 371 Date: Jan. 23, 2019

(30) Foreign Application Priority Data
Aug. 4, 2016 (DE) 10 2016 009 407.9
Mar. 10, 2017 (DE) 10 2017 002 274.7

(51) Int. Cl. B29C 48/00; B29C 48/10; B29C 48/21; B29C 48/25; B29C 48/335

(52) U.S. Cl. CPC B29C 48/0018; B29C 48/10; B29C 48/3366; B29C 48/2566; B29C 48/3363; B29C 48/21

(57) ABSTRACT

The invention relates to a multi-layer blowing head for a blown film installation, to a blown film installation, and to a method for operating a blown film installation. Specifically, according to the invention, a component is included on the opposite side of a distributor plate of a distributor plate set for a spiral distributor, wherein part of the spiral distributor is formed out of the opposite side of a distributor plate. The blowing head according to the invention for forming a multi-layer melt flow makes it possible, in the case of suitable operating parameters, to prevent the occurrence of spiral strips or at least to make said spiral strips less pronounced.

The invention relates to a multilayer blowing head for a blown film installation, a blowing film installation as well as a method of operating a blowing film installation.

In particular, the invention relates to a blowing head for a blowing film installation, for forming a multi-layered annular melt stream in an ring channel and for outputting the melt stream out of a ring slit nozzle to form a film hose pipe, a blowing film installation with such a blowing head and a method for operating a blowing film installation to form a multi-layered annular melting stream in an ring channel and for outputting the melt stream from a ring slit nozzle for forming a film pipe.

The blowing head as the extrusion tool is the “heart” of the blowing film extrusion installation. The task of the blowing head—regardless of its specific design—is the formation of the melt of one or more melt strand or melt strands at the tool entrance to a uniform, thermally and mechanically homogeneous melt distribution over the annular gap-shaped outlet cross-section downstream at the tool exit.

The today commonly used types of blowing heads can be divided into two groups; namely, on the one hand in the group of axial spiral distributor in cylindrical or conical shape and on the other hand in the group of radial spiral distributors, also called as plate spiral distributor, spiral distributor or stack die, wherein there are also combined embodiments.

Common to all blowing heads is that the melt flow delivered by the extruder is first divided into several individual streams. For this purpose, mainly star and annular distribution systems are used. The so-called pre-distributors lead into spiral shaped channels that are incorporated either in a mandrel (spiral distributors) or a plate (radial spiral distributors) and circulates this or these in the form of a multiple thread.

The area, in which a tubular channel leads from the pre-distributor in the corresponding helix or spiral, is referred to as “gusset area”. The gusset area, as it is performed in the prior art is—described by means of an axial spiral distributor with vertical axis—characterized by
a predominantly horizontal edge between the spiral channel and the mostly smooth outer tool part, which extents with the spiral channel up to the—seen in direction of rotation of the spiral channel—first overlap with the against the direction of rotation of the spiral channel adjacent spiral channel. This edge forms with the mostly smooth outer tool part—seen in cross section—a corner. In this corner are significantly lower wall shear stresses than in the round areas of the spiral channel. As a result, this occurs in a range of a comparatively long residence time of the melt.
and a predominantly vertical edge, located at the beginning of the overlap between a first and a second spiral channel—seen in the direction of rotation—immediately before it, in the axial direction. This edge forms the boundary of the flow channel at the beginning of the bridge between the two previously mentioned spirals. The volume which flows through this bridge between the two spirals is low and is additionally delayed in the area of the edge. In other words—similar to the horizontal one edge—significantly lower wall shear stresses in the area of the vertical edge are provided, as in the remaining areas of the bridge between the spirals. Also in this area comparatively long residence times of the melt occur.

The geometric design of the gusset region according to the prior art, in particular those of the two edges, lead there in consequence of the wall adhesion of the melt there to significantly longer residence times and as a result to an inhomogeneous film structure (“spiral strips”, “portlines”). These long residence times means in addition, that a comparatively long rinsing time for changes in the film formulation, in particular with changes of the colour, is existing.

EP 1 784 297 B1 proposes, in multi-layer blowing heads with axial distributor for multilayer films, to arrange the spiral distributor of the inner melt channel on—in relation to the central axis of the film blowing head inside—the boundary wall and to arrange—in relation to the central axis of the film blowing head outside—the spiral distributor on the outer boundary wall.

To avoid spiral stripes often special courses of the spiral channel geometry are proposed in the gusset area. As an example, the DE 10 2010 023 302 A1 of the same applicant is mentioned.

The invention is based on the object, to provide to the prior art an improvement or an alternative.

According to a first aspect of the invention, the object is solved by a blowing head for a blowing film installation, for forming a multi-layered annular melt stream in one ring channel by means of several—in the direction of the ring channel leading—set of spirals (German: Wendelscharen), as well as for outputting the melt stream from a ring slit nozzle to form a film hose pipe, wherein the ring channel leads in an extrusion direction to the annular slit nozzle with a distributor plate package, which forms a pre-distributor, a set of spirals and a distributor plate channel, wherein in a distribution flow direction, the pre-distribution leads over the set of spirals and the distributor plate channel into the ring channel, whereby the set of spirals has a spiral channel exit direction which is parallel to the extrusion direction in or opposite the extrusion direction, wherein a first set spirals is arranged in relation of the extrusion direction of the blowing head at least partially upstream of a first distributor plate channel, wherein the spiral channel exit direction of this part is pointing in the extrusion direction, or the spiral channel exit direction of a first spiral drove is pointing with respect to the extrusion direction at least partially radially outward, wherein a second set of spirals is arranged with respect to the extrusion direction of the blowing head at least partially downstream of a second distributor plate channel, wherein the spiral channel exit direction of this part is facing in the extrusion direction.

Conceptually, the following is explained:

First of all, it should be noted that within the scope of the present patent application indefinite articles and numbers such as “one”, “two” etc. normally should be understood as “at least” information, so as “at least a . . . ”, “at least two . . . ” etc., unless it results explicitly stated in the context or is obvious or technically compelling to the skilled person, that only “exactly one . . . ”, “exactly two . . . ” etc. can or should be meant there.

Furthermore, it should also be expressly noted that in the context of the present patent application a “part” (German: Teil) of something should be understood that it can the whole part of something.

A “melt stream” is a matter stream of a molten thermoplastic plastic. A melt stream may be single-layered or multi-layered. A film-shaped melt flow is also referred to as a “melt film”.

A “ring channel” is an annular channel inside a blowing head of a blown film installation, which collects the melt flow of a distributor plate after its entrance in the ring channel or the melt streams of several distribution plates after their entrance in their ring channel and leads to the ring slit nozzle of the blowing head. The melt stream which leads in the interior of the ring channel to the ring slit nozzle can be with one layer or multi-layered. A ring channel can be arranged—viewed radially—outside a distributor plate, within a distributor plate or both, outside and inside different distributor plates.

A “spiral” is a helix. A distinction is made between cylindrical spirals, which extent in the axial direction of a cylinder or in the axial direction of a pointed cone and also called as “axial spiral”, and substantially radially extenting spirals, which are called as “radial spiral”. Spirals appear as set of spirals. If spirals appear as a set, one speaks of “set of spiral”, in particular of a “radial set of spiral” or an “axial set of spiral”.

A “ring slit nozzle” is a component or a set of components through which a melting stream leaves the blowing head of the blown film installation. A ring slit nozzle can have segmented actuators, which makes in the operation of the blowing head the thickness of melt flow adjustable.

A “film hose pipe” is a tube-shaped plastic film that leaves a blowing head of a blowing film installation in the direction of extrusion.

An “extrusion direction” is the direction in which a designated melt stream which leaves the ring slit nozzle. Usually today, an extrusion direction is vertical oriented in opposite to the direction of action of gravity.

A “distributor plate”, also referred to as “plate”, is a component of a blowing head of a blowing film installation, which by its shape, in particular by the shape of the distribution channels, a designated melt stream leads from the distributor plate entry in “distributor stream direction” to the distributor plate outlet, wherein the melt stream passes via the pre-distributor, a spiral distributor and a distribution channel, wherein the designated melt stream is distributed so that it leaves the distributor plate as largely homogeneous, continuous melt film.

A “pre-distributor” is a geometry that pre-distributes a melt stream coming from the extruder, that is, divides into several isolated melt streams. The “pre-distributor” can comprise in particular, a fishtail distribution, a deer antler distribution, drilling from a central region of the blowing head, a different design or a combined design.

A “spiral distribution” has a “set of spirals”. A “set of spirals” extents such that a melt stream extents, apart from an ever present circumferential direction, preferably in the radial or axial direction.

An “axial spiral distributor” can have, in particular a spiral distribution, a spiral helix (German: Spiralwendel) distribution, having a different design or a combined design.

A “radial spiral distributor” can have a radial spiral distribution, a spiral helix distribution, a fishtail distribution a deer antler distribution, a different design or have a combined design.

A “radial spiral distribution” has a “radial set of spirals”. A “radial set of spirals” is a set of spirals that extents such that a melt stream, apart from an always present circumferential direction, extents preferably in the radial direction.

A “distributor plate channel” is a slit between a distributor plate and another component of the blowing head for a blown film installation or a gap between two distributor plates, which is designed to be flowed by a designated melt stream. At the end of the distribution plate channel, a designated melt stream leaves a distributor plate as a homogeneous continuous melt film. The distributor plate channel is fed from the set of spirals.

The “distribution flow direction” is a fictitious direction. Whether every single particle in the flowing melt will actually flow exactly in the distribution flow direction is certainly more than questionable. The distribution flow direction should therefore here be understood as purely geometric, theoretical direction. The distribution flow direction is aligned radially in case of plate spiral distributor. In this case, the distributor stream direction is able pointing outwards or inwards.

A “distribution plate package” is an assembly of a blowing head of a blowing film installation, which is composed of distributor plates. The distributor plates of a distribution plate package may be associated with one or more melt feeds. In particular, different melt streams may be passed to the individual distribution plates, so that the distributor plate package is performed to produce e a multi-layered foil film by superimposing several melt films. The different melt layers can, if the distribution plates are connected with different distributors, have different starting materials, so that the distributor plate package may be configured to create a multilayer melt film.

A “distributor plate entry” is the location at which a designated melt stream enters into the distributor plate. In most cases, a distributor plate entry is a bore. However, a distributor plate entry can also be made deviating.

A “distribution plate exit” is the location where a designated melt stream is the one that leaves the distributor plate. In most cases, the distributor plate entry is designed so that a designated melt flow leaves the distributor plate annular radially.

A “spiral channel exit direction” is the idealized exit direction of a designated melt stream from a spiral channel. The spiral channel exit direction extents always parallel to the extrusion direction. Whether every single particle in the flowing melt actually will flow exactly in the spiral channel exit direction is certainly more than questionable. The distribution flow direction should therefore here understand as purely geometric, theoretical direction. The spiral channel exit direction can be oriented in or can be oriented counter to the extrusion direction.

Under “downstream” is meant “towards” the exit of the designated melt stream from the “ring slit nozzle”. Thus, in the concrete case, there is a first object of the blowing head with respect to the extrusion direction of the blow head downstream of a second object of the bowing head, so the projected distance on the extrusion direction between the exit of the designated melt stream from the ring slit nozzle and the first object is smaller than that of the second object.

A “gusset area” is the area in which the designated melt stream flows through the outlets of the pre-distributor in the spiral distributor.

The prior art provided that the opposite side of a distribution plate of a distribution plate package had a predominantly flat geometry, so no worked out spiral distributor was provided.

Deviating is proposed here, a component on the opposite side of a distributor plate of a distributor plate package, in particular a different distribution plate or a different component, to include for a spiral distributor, wherein a part of the spiral distributor from the opposite side of a distributor plate is worked out.

In a preferred embodiment, the set of spirals is arranged in relation to the extrusion direction of the blowing head at least partly downstream of the distributor plate channel, so that the set of spirals hangs up on its layer of the designated melt stream against the extrusion direction on the designated melt flow in the distribution plate channel.

Thus, concretely, inter alia, an embodiment is conceivable in which a distribution plate package is designed such that different layers of a designated melt stream are placed from different spiral channel exit directions. In particular is regarded an embodiment in which the outermost layers of a designated melt stream are each placed from the outside, that is, the spiral channel exit directions of the spiral responsible for the outermost layers of the designated melt stream is oriented at least in part in the direction of the designated melt stream.

Advantageously, it can be achieved by a suitable operating parameter that the occurrence of spiral strips is prevented or is at least greatly reduced in its dimension.

Preferably, the second set of spirals is in a volume consideration predominantly, preferably completely arranged with respect to the direction of extrusion downstream of the distributor plate channel.

Conceptually, the following is explained:

A “volume view” of a design designates a test of a design according to the criterion of the volume.

Thus, it is conceivable that both the distributor plate and the opposite side of a distributor plate may have a part of the second set of spirals. Referring to the total worked out volume of the second set of spirals is this predominantly, preferably completely arranged, with respect to the extrusion direction of the blowing head downstream of the distributor plate channel.

Advantageously, this can be achieved in that, by a suitable operating parameter, the occurrence of spiral strips is prevented or at least greatly reduced in its extent.

Optionally, the second set of spirals in a channel path course view is arranged predominantly preferred completely, with respect to the extrusion direction downstream of the distributor plate channel, i.e. on the opposite side of a distributor plate.

Conceptually, the following is explained:

A “channel path course” describes the route of a course of a channel.

A “channel path course view” of an extent denotes a test of extent according to the criterion of the channel path course.

Thus, concretely, among other things it is conceivable that both the distributor plate and the opposite side of a distributor plate can have a part of the second set of spirals. Referring on the channel path course of the second set of spirals this is arranged predominantly, preferably completely, downstream with respect to the extrusion direction of the blowing head of the distributor plate channel, i.e. on the opposite side of a distributor plate.

Advantageously, it can be achieved by suitable operating parameters that the occurrence of spiral strips are prevented or are at least greatly reduced in it's extent.

Preferably, the second set of spirals is located in a channel path course view at least a last third of the channel path course downstream of the distributor plate channel, preferably at least a second half, in particular the entire channel path course.

In a suitable embodiment of the design is conceivable that both the distributor plate as well as the opposite side of a distributor plate may have a part of the second set of spirals. Referring to channel path course of the second set of spirals at least a last third of the channel path course is located, preferably at least one second half of the channel course is located, in particular the entire channel course with respect to the extrusion direction of the blowing head downstream of the distributor plate channel is located, that is, on the opposite side of a distribution plate.

Advantageously it can be achieved by suitable operating parameter that the occurrence of spiral strips are prevented or are at least greatly reduced in its extent.

Optionally, the distribution plate package consists of extrusion-layered plates in the direction of the extrusion direction, wherein in any case, with respect to the downstream of the extrusion direction of the distributor plate package, a set of spirals has recesses.

Conceptually, the following is explained:

A “recess” refers to a local depression of a component geometry. Examples of a recess are the geometry of a spiral distributor or the geometry of a distributor plate channel, which are worked out from a distributor plate.

Advantageously, it can be achieved by suitable operating parameters that the occurrence of spiral strips are prevented or are at least greatly reduced in its extent.

Optionally, the distribution plate package consists of extrusion-layered plates, wherein in any case, the distributor plate—with respect to the downstream of the extrusion direction of the packs—comprises the set of spirals and the distributor plate channel as recesses.

In a suitable design form, it is concretely conceivable, inter alia, that both the set of spirals and the distributor plate channel are incorporated in the opposite side of a distributor plate.

Advantageously, doing so, it can be achieved that—by a suitable operating parameters—an occurrence of spiral strips is prevented or is at least greatly reduced in its extent.

Preferably, the downstream plate of the distribution plate package forms—with respect to the extrusion direction—the outermost laying channel in relation to the ring channel.

It is concretely conceivable, among other things, that the housing of the blowing head of the blown film installation forms the outermost laying channel in relation to the ring channel.

Advantageously, it can be achieved by suitable operating parameters that the occurrence of spiral strips is prevented or is at least greatly reduced in its extent.

Optionally, in addition to the distributor plate package described above, the blowing head has another distributor plate package.

This makes it possible with suitable design and with different distribution plate packages to achieve different layer thicknesses of the melt stream. So a distribution plate package—especially for a specific functional layer—can be performed in the designated foil.

Advantageously, doing so, it can be achieved that the extent of functional properties of the film can be improved.

Preferably, the blowing head comprises—in addition to the distribution plate package described above—an axial spiral distributor part.

Conceptually, the following is explained:

An “axial spiral distributor” is an axially extending design of a distribution, in particular an axial distribution, i.e. a geometry inside and/or on the surface of a mandrel, which distributes a designated melt stream, so that it has downstream of the mandrel properties, as homogeneous as possible.

An “axial spiral distributor part” is a component or an assembly that forms an axial spiral distributor.

It is concretely conceivable, inter alia, to realize the layer structure of the designated film with different distributors, wherein at least one radial spiral distributor and an axial spiral distributor come to use combined.

Advantageously, thus, it can be achieved that different layers of the film can be built with the optimal distribution type.

Furthermore, the construction concept of a mixed distributor can provide geometric advantages. So it is conceivable that the necessary space and/or the necessary material used can be reduced for a corresponding blowing head.

Optionally, the distribution plate package described above is one of those embodiments described above which may be also a combined embodiment with the individual features described above.

Advantageously, this can be achieved in that the accessibility to the distribution package is improved. Thus, a change or a repair or maintenance can be performed faster.

According to a second aspect of the invention, the object is achieved by a blown film installation with a blow head according to a first aspect of the invention.

It is understood that the advantages of a blowing head for a blown film installation, for forming a multi-layered annular melt stream in a ring channel by means of several in the direction of ring channel leading set of spirals, as well as to exit the melt stream from a ring slit nozzle to form a film hose pipe, wherein the ring channel leads in an extrusion direction to the ring slit nozzle, forms with a distribution plate package, which forms a pre-distributor, a set of spirals and a distributor plate channel, wherein, in a distribution flow direction, the pre-distribution leads over the set of spirals and the distributor plate channel leads into the ring channel, wherein the set of spirals has a spiral channel exit direction, which is parallel to the extrusion direction in or is in opposite to the extrusion direction, wherein a first set of spirals is arranged with respect to the extrusion direction of the blowing head at least partially upstream of a first distributor plate channel, wherein the spiral channel exit direction of this part points in the extrusion direction, or the spiral channel exit direction of a first set of spirals points at least partly radially outward with respect to the extrusion direction, wherein a second set of spirals is arranged with respect to the extrusion direction of the blowing head at least partly downstream of a second distributor plate channel, wherein the spiral channel exit direction of this part is facing against the extrusion direction and as above described extents directly on a blowing film plant with such a blowing head.

It should be expressly understood that the subject of the second aspect can be advantageously combined with the object of the above aspect of the invention.

According to a third aspect of the invention, the object is solved by a method for operating a blowing film installation for forming a multi-layered annular melt stream in a ring channel by means of several in the direction of the annular channel leading sets of spirals, and for exiting the melt stream through a ring slit nozzle to form a hose pipe, wherein the ring channel leads in an extrusion direction to the ring slit nozzle, wherein the layers of the film hose pipe are produced with a distributor plate package and melting is guided through a set of spirals in a spiral channel exit direction parallel to the extrusion direction in or against the extrusion direction, wherein the melting of a first layer is guided with respect to the extrusion direction of the blowing head at least partly by a set of spirals arranged upstream of a first distributor plate channel in the extrusion direction of the bowing head, or the melting of a first layer is guided with respect to the extrusion direction of the blowing head at least in part radially outward, wherein the melt of a second layer is guided with respect to the extrusion direction of the blowing head at least in part by a downstream of a second distributor plate channel arranged set of spirals against the extrusion direction of the blowing head.

The state of the art previously provides that the set of spirals has placed their layer with the extrusion direction on the melt in the distributor plate channel. Notwithstanding, it is proposed here that the melt is guided by the set of spirals in relation on the extrusion direction of the blowing head at least partially downstream of the distributor plate channel, so that the set of spiral lays up on their layer of the melt stream against the extrusion direction the melt in the distributor plate channel.

Advantageously, doing so, it can be achieved that by a suitable operating parameters an occurrence of spiral strips can be prevented or can be at least greatly reduced in its extent.

It should be expressly advert that the subject matter of the third aspect can be advantageously combined with the subject matter of the above aspects of the invention, namely either individually or in any combination.

The invention will be explained below with reference to an exemplary embodiment explained in more detail on the drawing. There is shown:

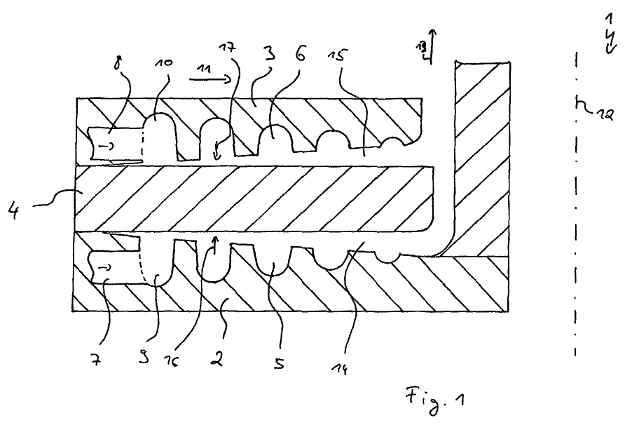

FIG. 1 shows schematically in a radial section one half of a plate distributor with spiral coil distributor, at which melt is fed outside in spiral channels and an annular melt stream is generated, and

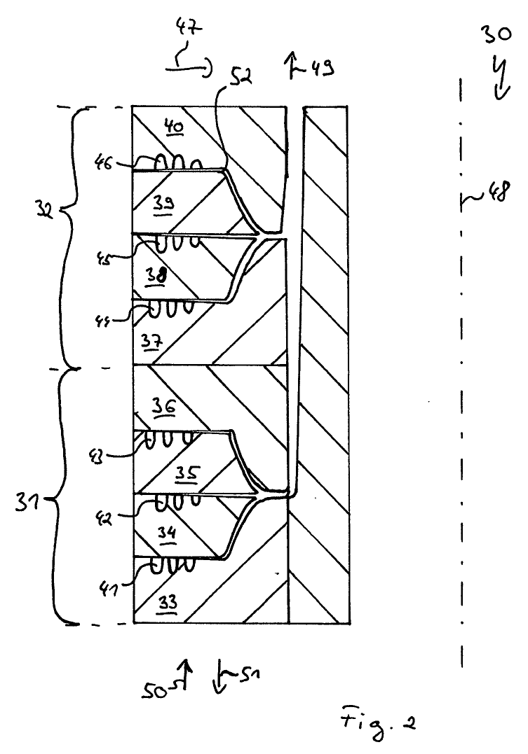

FIG. 2 shows schematically in a radial section one half of a blowing head of two distribution plate packages with spiral coil distributors, in which melt is fed outside in spiral channels and an annular melt stream is generated.

The distribution plate package 1 in FIG. 1 consists essentially of a first distributor plate 2, a second distributor plate 3 and a counter plate 4. The distributor plates 2, 3 are just like the counter-plate 4 horizontally.

In the distributor plates 2, 3 a set of spirals 5, 6 (identified by way of example) are introduced.

All edges of the set of spirals 5, 6 and the edges of the distributor plates 2, 3 and the counter plate 4, which come into contact with the designated melt stream, can be rounded with respect to the risk of flow separation in the distributor plate package 1 (not shown).

At the distributor plate package 1, the plastic melt is guided in operation, starting from pre-distribution channels 7, 8 at the beginnings of set of spirals 9, 10. In a distribution flow direction 11, which is radially toward a central axis 12, while the central axis 12 is parallel with an extrusion direction 13, a channel depth of the the set of spirals 5, 6 decreases, wherein a distributor plate channel 14, 15 becomes larger in the course of the distribution flow direction 11.

A spiral channel exit direction 16 of the designated melt of the first distributor plate 2 is parallel to the direction and in the direction of the extrusion direction 13, wherein the set of spirals 5 of the first distributor plate 2 is located upstream of the distributor plate channel 14.

A spiral channel exit direction 17 of the designated melt of the second distributor plate 3 extents parallel to the direction and opposite to the direction of the extrusion direction 13, wherein the set of spirals 6 of the second distributor plate 3 is located downstream of the distributor plate channel 15.

A blowing head 30 in FIG. 2 consists essentially consists of a first distributor plate pack 31 and a second distribution plate pack 32, wherein the distribution plate packages extents horizontally.

The first distributor plate package 31 consists essentially of three distributor plates 33, 34, 35 and a counter-plate 36.

The second distributor plate package 32 also consists essentially of three distribution plates 37, 38, 39 and a counter plate 40.

In the distributor plates 33, 34, 35, 37, 38 are introduced set of spirals 41, 42, 43, 44, 45 (exemplary marked).

In the counter plate 40 are also introduced a set of spirals 46 (marked by way of example).

All edges of the set of spirals 41,42,43,44,45,46 and the edges of the distributor plates 33, 34, 35, 37, 38, 38 and the counter plates 36, 40, which with the designated melt stream comes into contact with regard to the risk of flow separation in the blowing head 30 are rounded (not shown).

In a distribution flow direction 47, which is radially toward a central axis 48, while the central axis 48 is parallel with an extrusion direction 49, a channel recess of the set of spirals 41, 42, 43, 44, 45, 46 decreases, wherein a distributor plate channel (schematically indicated, not numbered) in the course of the distribution flow direction 47 becomes larger.

The distribution plate packs 31, 32 are fed in operation with plastic melt starting from pre-distribution channels (not shown) in the distributor plates 33, 34, 35, 37, 38, 39. The designated plastic melt passes over the beginning of the set of spirals (not shown) in the set of spirals 41, 42, 43, 44, 45, 46.

A spiral channel exit direction 50 of the designated melt of the distributor plates 33, 34, 35, 37, 38 runs parallel to the direction and in the direction of the extrusion direction 49, wherein the set of spirals 41, 42, 43, 44, 45 (identified by way of example) of the distributor plates 33, 34, 35, 37, 38 is arranged upstream of the respective distributor plate channels (schematic indicated, not numbered).

A spiral channel exit direction 51 of the designated melt of the distributor plate 39 over the set of spirals 46 in the counter-plate 40 runs parallel to the direction and opposite the direction of the extrusion direction 49, wherein the set of spirals 46 (exemplary marked) of the distributor plate 39 is arranged downstream of the associated distributor plate channel 52 (indicated schematically).

### LIST OF REFERENCE NUMBERS USED

1 distribution plate package
2 first distributor plate
3 second distributor plate
4 counter plate
5 set of spirals
6 set of spirals
7 pre-distribution channel
8 pre-distribution channel
9 beginning of set of spirals
10 beginning of set of spirals
11 distribution flow direction
12 axis
13 extrusion direction
14 distribution plate channel
15 distribution plate channel
16 spiral channel exit direction
17 spiral channel exit direction
30 blowing head
31 first distributor plate package
32 second distribution plate package
33 distributor plate
34 distributor plate
35 distributor plate
36 counter plate
37 distribution plate
38 distribution plate
39 distribution plate
40 counter plate
41 set of spirals
42 set of spirals
43 set of spirals
44 set of spirals
45 set of spirals
46 set of spirals
47 distribution flow direction
48 axis
49 extrusion direction
50 spiral channel exit direction
51 spiral channel exit direction
52 distribution plate channel

1. blowing head for a blowing film installation,
for forming a multi-layered annular melt stream in a ring channel by means of several set of spirals leading in the direction of the ring channel,
and for exiting the melt stream from a ring slit nozzle for forming a film hose pipe, wherein the ring channel leads in an extrusion direction to the ring slit nozzle,
with a distributor plate package, which forms a pre-distributor, a set of spirals and a distribution plate channel, wherein in a distribution flow direction the pre-distribution leads over the set of spirals and the distributor plate channel into the ring channel,
wherein the set of spirals comprises a spiral channel exit direction, which is arranged parallel to the extrusion direction in or against the extrusion direction,
wherein a first set of spirals is arranged with respect to the extrusion direction of the blowing head is at least partially disposed upstream of a first distributor plate channel, wherein the spiral channel exit direction of this part points in the extrusion direction,
or the spiral channel exit direction of a first set of spirals points radially outward with respect to the extrusion direction at least partially,
characterized in that
a second set of spirals is arranged with respect to the extrusion direction of the blowing head at least partly downstream of a second distributor plate channel, wherein the spiral channel exit direction of this part points in the extrusion direction.

2. Blowing head according to claim 1, characterized in that the second set of spirals is arranged in consideration of a volume predominantly, preferably completely, in relation of the extrusion direction downstream of the distributor plate channel.

3. Blowing head according to claim 1, characterized in that
the second set of spirals is predominantly arranged in a channel course view, preferably completely,
downstream of the distributor plate channel with respect to the direction of extrusion.

4. Blowing head according to claim 1, characterized
in that the second set of spirals is arranged in a channel course view, at least a last third of the channel course, downstream of the distributor plate channel, preferably at least a second half, in particular the entire channel course.

5. Blowing head according to claim 1, characterized
in that the distribution plate package consists of layered plates in extrusion direction,
wherein, in any case, the plate which is arranged downstream with respect to the extrusion direction plate comprises the set of spirals as recesses.

6. Blowing head according to claim 5, characterized in that the distributor plate package consists of stacked plates in the direction of extrusion, wherein, anyway, with respect to the extrusion direction, the downstream plate of the distribution plate package comprises a set of spirals and comprises the distributor plate channel as recesses.

7. Blowing head according to claim 1, characterized
in that, with respect to the extrusion direction, the downstream plate of the distribution plate package forms the outermost laying channel in relation to the ring channel.

8. Blowing head according to claim 1, characterized
that the blowing head comprises in addition to the distribution plate package described above another distributor plate package.

9. Blowing head according to claim 1, characterized
that the blowing head comprises in addition to the distribution plate package described above an axial spiral distributor part.

10. Blowing head according to claim 8, characterized in that the distributor plate package is arranged on top.

11. Blowing film installation with a blowing head according to claim 1.

12. Method for operating a blowing film installation for forming a multilayered annular melt stream in a ring channel by means of several, in the direction ring channel leading, set of spirals,
and for exiting the melt stream through a ring slit nozzle to form a film hose pipe, wherein the ring channel leads in an extrusion direction to the ring slit nozzle,
wherein the layers of the film hose pipe are produced with a distributor plate package and melt is guided through by a pre-distributor for each melt, and is guided by a set of spirals and a distributor plate channel, wherein in a distribution flow direction the pre-distribution leads over the set of spirals and over the distributor plate channel into the ring channel,
wherein the melt in guided through a set of spirals in spiral channel exit direction parallel to the extrusion direction or against the extrusion direction,
wherein the melt of a first layer is guided, with respect to the extrusion direction of blowing head at least in part by an upstream of a first distributor plate channel arranged set of spirals in the extrusion direction of the blown head,
or the melt of a first layer is guided, at least partially, with respect to the extrusion direction of the blowing head radially outward,
characterized in that
the melt of a second layer is guided with respect to the extrusion direction of the blowing head, at least in part, by a downstream of a second distributor plate channel set of spirals arranged against the extrusion direction of the blowing head.
